(19) United States
(12) Patent Application Publication
(10) Pub. No.: US 2002/0038285 A1
(43) Pub. Date: Mar. 28, 2002

(54) System and method for providing a loan marketplace

(76) Inventors: Marshall K. Golden, Mission Viejo, CA (US); Peter Hong, Irvine, CA (US); Frank X. Ballmann, Arlington, VA (US)

Correspondence Address: SHAW PITTMAN LLP, 1650 TYSONS BOULEVARD, MCLEAN, VA, 22102, US

(21) Appl. No.: 09/946,559

(22) Filed: Sep. 6, 2001

Related U.S. Application Data
(60) Provisional application No. 60/231,241, filed on Sep. 8, 2000.

(51) Int. Cl. G06F 17/60

(52) U.S. Cl. 705/38; 705/37

(57) ABSTRACT

A marketplace that facilitates the business of education finance by providing a globally accessible exchange that facilitates transactions between educational institutions and lenders, and between loan sellers and loan buyers. Specifically, the present invention provides a system and method for selecting a preferred lender list, and a system and method for selling loan portfolios and forward purchase commitments. The present invention also provides a system and method for conducting an auction over a global computer network (e.g., the Internet), which enables the offer or that posts the auction to choose, after receiving proposals, whether to select bidders that qualify for a second round of bidding and continue with bidding, or award winners and conclude the auction.

This application claims the benefit of the filing date of U.S. Provisional Application No. 60/231,241, filed Sep. 8, 2000, which is hereby incorporated by reference in its entirety.

### BACKGROUND

### FIELD OF THE INVENTION

The present invention broadly relates to the field of electronic commerce and global network information management services, and more specifically, to a system and method for providing an electronic marketplace in which higher education institutions, lenders, and loan buyers can communicate and connect to conduct business. The invention facilitates an educational institution's selection of “preferred lenders,” which provide students of the educational institution with educational loans. The invention also facilitates transactions between financial institutions for the sale of education loan portfolios and forward purchase commitments.

### BACKGROUND OF THE INVENTION

In the United States, lenders typically offer several types of education loan products. The first loan product is a federally-sponsored, guaranteed loan provided through a private lender. The federal government guarantees payment to the private lender and, in return, the lender agrees to make loans at or below the statutorily capped interest rates. The federally-sponsored, guaranteed loans of one private lender tend to differ very little from loans of another lender because of strict government regulations. However, some competition exists on the basis of quality of loan servicing, economic benefits offered to borrowers for on-time repayment, and customer service. Federally guaranteed loans are issued under the Federal Family Education Loan Program (FFELP). As an indication of the huge size of this market, in the year 2000, analysts estimate that lenders will originate over $25 billion in FFELP loans during the academic year at colleges and universities across America. Analysts expect this figure to rise to almost $35 billion by 2004. Comparing these numbers with the $12 billion volume in 1990 demonstrates a solid growth trend.

The second loan product is a private education loan provided by a private lending institution. In general, private education loans may, but need not, be insured or guaranteed, or have some other form of credit enhancement. The interest rates on private education loans are typically uncapped, except by state usury laws, and are subject to substantially less regulation than federally guaranteed loans. As such, lenders compete far more based on interest rates and other economic benefits. Lenders also typically offer services such as debt counseling, exit (loan repayment) counseling, and repayment planning services in connection with both types of education loans. With these different available services, a student may derive more benefits from one lender as opposed to another. Therefore, in addition to competition based on tangible factors such as interest rates and other economic benefits, lenders compete based on intangible factors such as level of service.

A third type of education loan product, not made by private lenders, is a loan issued under The William D. Ford Federal Direct Loan Program (FDLP). The FDLP, in which the United States Department of Education (USDE) is the sole lender, generates $13 billion in private education loans annually, an amount expected to increase to more than $15 billion by 2004. Overall, almost 6 million students and parents receive FFELP loans, FDLP loans, and private education loans. By 2004, analysts expect that number to rise to 8 million.

Overall, the market for these three types of education loan products will undoubtedly expand. There are two trends driving education loan volume higher: the number of students and the growth rates of tuition cost relative to income. The increased recognition of the value of higher education and the growing need to update worker skill sets has swollen the ranks of students. The upcoming “echo boom” generation will further increase the supply of students in post-secondary educational institutions (e.g., colleges, universities, vocational institutions, trade schools, technical schools, and proprietary schools). As for the second trend, the cost of attending college doubled in the 1990's, while median and disposable income rose only 50%. Demand-pull pressure on the cost of attendance is likely to continue to drive these costs higher. As the growth rate in the cost of attendance continues to exceed the growth rate of available income, loan demand increases to fill the gap.

The loan origination market generally involves two classes of participants: educational institutions, whose students require loan funding; and originating lenders, the providers of loan funding. Today, there are over 4,000 colleges and universities and over 1,000 eligible lenders participating in the FFELP and the FDLP. Other participants in the education loan industry include servicers, guaranty agencies, secondary markets, and the USDE.

Nearly a decade ago, many schools began to recommend specific lenders to students and their parents in an effort to improve the efficiency of their operations by reducing the number of lenders from whom they received applications. Now, most schools provide these recommendations through “preferred lender lists.” Using these preferred lender lists, schools have been able to streamline their operations and assure service quality levels for their financial aid offices and student and parent borrowers.

Generally, schools choose four to six preferred lenders to recommend to students. The students are not required to use the preferred lenders; however, most students do. Thus, being a preferred lender is a considerable advantage for the lending institutions. Indeed, a lender must gain placement on a preferred lender list to generate any significant education loan volume at a school.

In the past, schools have typically chosen preferred lenders based on subjective and arbitrary criteria, such as perceptions of branding and personal relationships, rather than considering the objective advantages that one loan program holds over another. In fact, traditionally, loan offerings have tended to be generic, without reflecting the economics of loans at individual schools. Despite the fact that loans vary in value from school to school because of differences in average borrower indebtedness and default rates of their respective students, there is little effective differentiation between loans on an economic basis. Interest rate terms vary little, as most federally guaranteed loans for tuition, room, and board are set at the statutory rate ceiling. In the end, because of the large number of educational institutions, lenders have relied on the subjective criteria in making the preferred lender list, rather than tailoring loan program offerings for individual schools.

In contrast to these generic loan offerings, educational institutions would prefer loan programs that satisfy their individual needs and those of their students. For example, the educational institutions would prefer to set minimum requirements for service options, service quality, and linkage to supplemental private loan programs. Thus, educational institutions would prefer lenders to accommodate their individual administrative needs as well as the specific financial and service needs of their typical student. In other words, educational institutions would prefer that lenders provide customized loan programs.

To obtain this customization and extract further value for their student and parent borrowers, some educational institutions issue requests-for-proposals (RFPs) for their education loan offerings. Unfortunately, this RFP process is extremely time-consuming for the schools and the responding lenders. The cost and complexity of responding to RFPs and the hitherto regional focus of the banking industry have limited the number of responding lenders and the quality of their responses.

Traditionally, choosing preferred lenders with this RFP process has involved a slow, tedious, paper-based process. In the typical scenario, a university publishes a request-for-proposal, waits to receive proposals on paper, evaluates the proposals in light of loan program criteria listed in the RFP, negotiates back and forth with lenders who have submitted proposals, and awards placement on the preferred lender list to the lenders that best fulfill the needs of the students and university. The timing of the process is often arbitrary and depends largely on the habits of the university. For example, some universities publish an RFP and wait as proposals dribble in. Other universities set bidding deadlines. Still others forgo the RFP entirely and wait for lenders to market directly to them. Thus, there remains a need for an efficient way for universities to select preferred lenders that offer customized loan programs.

Similar to the difficulties associated with the preferred lender selection process, the education loan market suffers from drawbacks related to sales of education loans on the secondary market. In this secondary market, education loan lenders seek to capitalize on the significant pool of fungible loan assets that they generate, by selling those assets for substantial premiums.

The secondary market has two primary segments: the spot market and the forward purchase commitment market. The spot market for loan portfolio sales consistently averages at least $2 billion annually. In addition, periodic extraordinary spot sales take place, which may swell the size of the market by 100% or more in any given year. The forward purchase commitment market has annual volume of $10-20 billion. Existing outstanding privately-held education loan volume (FFELP plus private loans) is about $130 billion, and the federal government holds about another $60 billion (FDLP loans plus defaulted FFELP loans). The combined outstanding loan volume is projected to exceed $260 billion in 2004. Any of these portfolios may come onto the market and expand annual loan sale volumes, as they have historically. Unfortunately, there are no marketplace tools or platforms in place to maximize competition and pricing for loan holders, and to facilitate and encourage such loan sales.

Despite the fact that the federal government guarantees the education loan instrument and the fact that the opportunity exists to earn interest at spreads of more than two percent over Treasury bill rates, there have been few new entrants to the education loan marketplace. Portfolios are purchased predominantly by approximately forty secondary markets specific to the industry. The largest national secondary market, USA EDUCATION™, purchases about 40 percent of all FFELP loans, with no other secondary market having more than a 10 percent market share. Notably, over half of all the FFELP loans are sold either on the spot market or at a predetermined future time and price under terms of a pre-negotiated forward purchase commitment (FPC).

The increasing costs associated with the complex technologies for originating and servicing education loans have forced virtually all lenders to outsource some or all aspects of the education loan origination and servicing processes. The secondary markets have contractual or ownership affiliations with the loan guaranty agencies and servicers that do most of these outsourced services. As a result, many lenders have moved toward the FPC approach to gain favorable terms for loan origination and/or loan servicing. While some lenders periodically sell loans in the spot market, the appearance of a portfolio on the spot market increasingly coincides with a lender's decision to change business models or to generate additional income in the current period.

Traditionally, loan sellers and buyers have negotiated loan sales and future commitments through a series of face-to-face meetings, letters, calls, and faxes. Requiring such an investment in time and effort, sales are therefore often a function of personal relationships, relying on the skills, knowledge, and contacts of the individuals involved. In fact, most lenders negotiate only with secondary markets with which the lenders have existing relationships, such as Sallie Mae and a local secondary market. Thus, lenders always ignore or exclude some potential buyers from a specific sale transaction because information does not circulate widely or swiftly enough.

In the end, having contacted only a limited number of potential buyers, loan sellers must decide among the small pool of offers. Unfortunately, the loan sellers do not explore the full range of possible buyers or potentially more profitable alternatives, such as segmenting the offering and sale of their portfolio or forward purchase commitment. Therefore, lender-sellers unnecessarily reduce their access to pricing information and marketing alternatives. Thus, there remains a need for an efficient process for these lenders to obtain a broad range of competitive bids for their loan portfolios and forward purchase commitments.

### SUMMARY OF THE INVENTION

In light of the deficiencies in the prior art, the present invention provides an efficient, open, and neutral marketplace that facilitates the business of education finance. The present invention provides a globally accessible exchange that facilitates transactions between educational institutions and lenders, and between loan sellers and loan buyers. Specifically, the present invention provides a system and method for selecting lenders for placement on a preferred lender list, and a system and method for selling loan portfolios and forward purchase commitments.

In an embodiment of the present invention, which is referred to herein as the COLLEGE AND UNIVERSITY EXCHANGE™ (CUE), educational institutions or schools use an Internet-based auction for the placement of lenders on preferred lender lists. CUE enables schools, especially post-secondary educational institutions such as colleges and universities, to post requests-for-proposals, to receive and evaluate bid proposals from lenders, and to select from among the responding lenders for placement on the school's preferred lender list.

In another embodiment of the present invention, which is referred to herein as PORTFOLIO AND COMMITMENT EXCHANGE™ (PACE), participants in the higher education secondary market use an Internet-based auction for the sale of education loan portfolios and forward purchase commitments. In particular, PACE enables lenders to auction existing loans and forward purchase commitments to secondary markets and other loan buyers.

As used herein, “system administrator” refers to the administrator of the system and method of the present invention. For example, a web site host that is responsible for operating CUE and PACE would be a system administrator.

According to an embodiment of the present invention, as demonstrated in the CUE and PACE examples, the system and method provide an innovative auction that is implemented over a global computer network (e.g., the Internet) and that incorporates a unique multi-round format. According to this embodiment, the auction begins by posting a request-for-proposal from an offeror on a site (e.g., a web site) of the global computer network. The offeror is, for example, a school soliciting proposals for education loan programs, or is a loan seller soliciting offers to buy existing or future loan volume. The RFP establishes minimum specifications to which the offeror would like bid proposals to adhere.

The site receives proposals responding to the RFP and enables the offeror to evaluate the proposals. This evaluation can entail, for example, filtering the bids, exporting the bids for further analysis, and evaluating the profiles of the entities that furnished the proposals. The offeror then chooses either to award winners or to select bidders that qualify for a second round of bidding.

If the offeror chooses to select second round bidders, the site receives new proposals from the second round bidders and enables the offeror to evaluate the new proposals. Optionally, between rounds, the site allows the offeror to revise the RFP into a new RFP, if necessary, and posts the new RFP on the site. After the new proposals have been submitted for the second round, the offeror can then, again, choose either to award winners or to select bidders that qualify for another bidding round.

The offeror can continue with as many additional rounds as necessary to award winners. Once the offeror finally chooses to award winners, the winners are notified and the auction ends.

Unlike traditional single-round auctions, the auction process of the present invention creates a dynamic, responsive marketplace that facilitates swift and efficient transactions between marketplace participants. The multi-round auction method provides significant benefits to all marketplaces, but is particularly useful in the context of the education loan market.

Thus, the present invention provides an e-commerce platform for the business-to-business marketing of federally guaranteed and private education loans. By creating an Internet-based exchange for the education finance marketplace, the present invention delivers a cost efficiency and an extended reach to players in a fragmented industry. The integrated online marketplaces embodied in CUE and PACE deliver these benefits, as discussed in more detail below.

College and University Exchange (CUE)

By establishing a competitive marketplace in which lenders bid against each other for placement and position on a school's preferred lender list, CUE helps educational institutions customize their loan programs and maximize benefits for borrowers and their parents and for the educational institution itself, while improving the process of selecting lending organizations. Benefits could include improved loan access, higher loan approval rates, improved services, preferred interest rates or fees, and borrower benefits.

CUE also benefits originating lenders by significantly reducing the cost of marketing to educational institutions, which has historically been over 50 basis points (as a percent of annual originations). For example, in an embodiment of the present invention, lenders that are placed on a preferred lender list pay a scalable fee that is approximately equal to ⅓ of the marketing expenses that they would have otherwise spent. Not having to spend on any other form of marketing, lenders gladly pay this fee. CUE also enables lenders with regionally limited marketing operations to seek loan volume opportunities nationwide. As no lender currently has a market share over 8%, the expanded reach and access to schools that CUE provides can help any lender grow.

Portfolio and Commitment Exchange (PACE)

PACE provides an electronic marketplace for bidding on education loan portfolios and forward purchase commitments. The participants include selling lenders on one side and prospective purchasers on the other.

For lenders, PACE maximizes gains and/or reduces costs on loan sales by subjecting the sale transaction to a rigorous and broadly-aimed auction process. It also enables buyers and selling lenders to reduce their costs by avoiding time consuming, one-on-one sales calls. In addition, PACE provides large, traditional loan holders, and potentially the federal government (which, while it does not currently sell FDLP loans, has statutory authority to do so under 20 U.S.C. §1087i), with access to a market-based loan sale mechanism. Providing an independent and neutral e-commerce auction site, PACE maximizes competition and pricing for loan sellers, and facilitates and encourages such loan sales.

Accordingly, an object of the present invention is to provide an electronic marketplace that supports transactions between offerors and bidders.

Another object of the present invention is to provide a system and method for facilitating the business of education loan finance.

Another object of the present invention is to provide a web-based information distribution system that supports the efficient and secure interfacing of educational institutions and lending institutions.

These and other objects, aspects, and advantages of the present invention are described in greater detail in the detailed description of the invention, the appended drawings, and the claims. Additional features and advantages of the invention will be set forth in the description that follows, will be apparent from the description, or may be learned by practicing the invention.

### BRIEF DESCRIPTION OF THE DRAWINGS

FIG. 1 is a schematic diagram of a system for conducting an auction over a global computer network, according to an embodiment of the present invention.

FIG. 2 is a flowchart outlining a method for conducting an auction over a global computer network, according to an embodiment of the present invention.

FIG. 3 is a flowchart outlining a user registration process, according to an embodiment of the present invention.

FIG. 4 is a flowchart outlining a method by which educational institutions participate in CUE auctions, according to an embodiment of the present invention.

FIG. 5 is a flowchart outlining a method by which originating lenders participate in CUE auctions, according to an embodiment of the present invention.

FIG. 6 is a flowchart outlining a method by which loan sellers participate in PACE auctions, according to an embodiment of the present invention.

FIG. 7 is a flowchart outlining a method by which loan buyers participate in PACE auctions, according to an embodiment of the present invention.

FIG. 8 is a schematic diagram of a user interface screen image of a template for creating an RFP, according to an embodiment of the present invention.

FIG. 9 is a schematic diagram of a user interface screen image through which a lender can search RFPs, according to an embodiment of the present invention.

FIG. 10 is a schematic diagram of a user interface screen image through which a lender can search educational institutions, according to an embodiment of the present invention.

FIG. 11 is a schematic diagram of a user interface screen image through which a lender creates a proposal corresponding to the RFP depicted in FIG. 8, according to an embodiment of the present invention.

FIG. 12 is a schematic diagram of a user interface screen image that shows the status of an educational institution's current auctions, according to an embodiment of the present invention.

FIG. 13 is a schematic diagram of a user interface screen image through which an educational institution can evaluate proposals and can select finalists or award winners, according to an embodiment of the present invention.

FIG. 14 is a schematic diagram of a user interface screen image that reports whether a particular lender has won an auction, for viewing by the particular lender, according to an embodiment of the present invention.

### DETAILED DESCRIPTION

According to representative embodiments, the system and method of the present invention provide an electronic marketplace for the selection of lenders for placement on a school's preferred lender list (CUE), and for the business-to-business marketing and sale of education loan portfolios and forward purchase commitments (PACE). In an embodiment of the present invention, the electronic marketplace uses an Internet-based auction that features selective filtering and multi-round bidding. Embodiments of the systems and methods of the present invention are presented below under the following headings:

I. Auction Method

II. College and University Exchange (CUE)

III. Portfolio and Commitment Exchange (PACE)

IV. Revenue Mechanisms

V. System Architecture.

### I. Auction Method

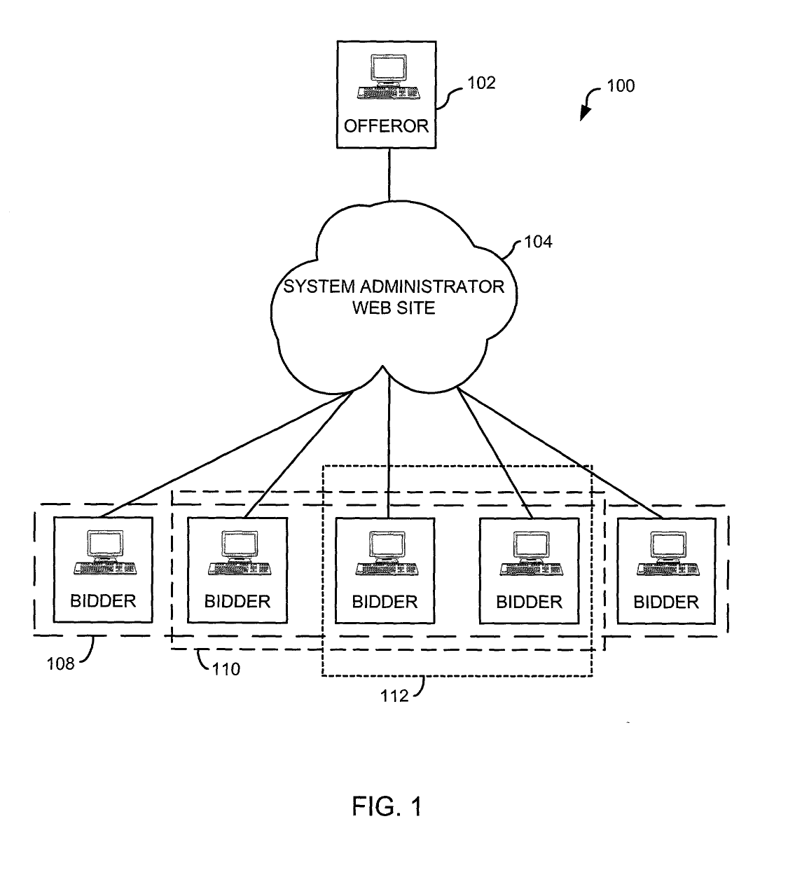

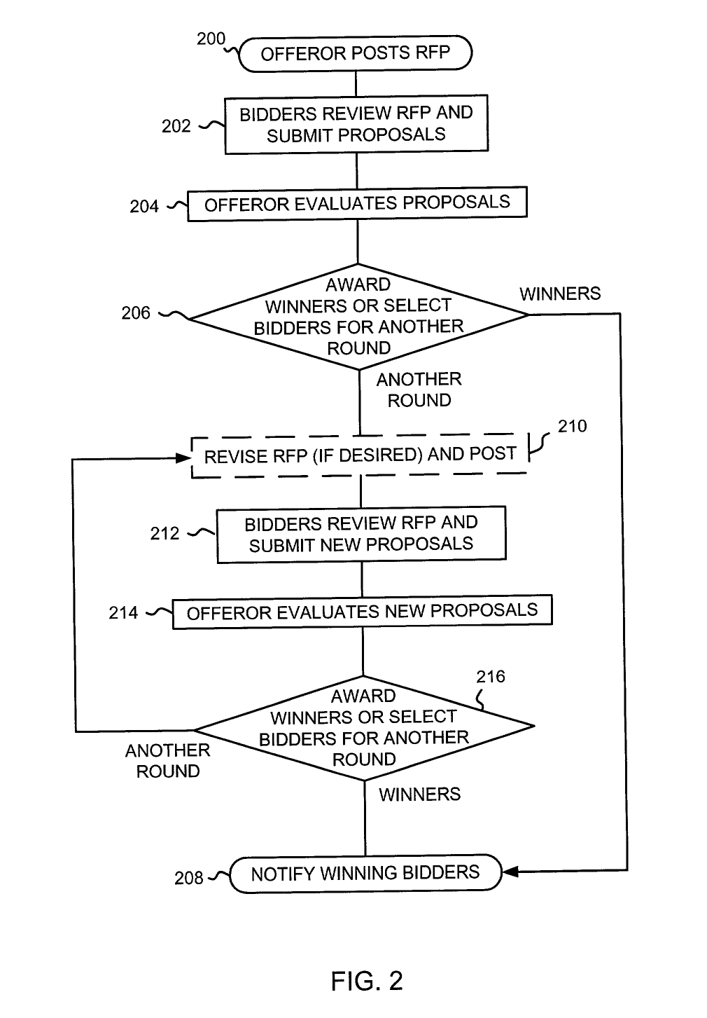

FIGS. 1 and 2 illustrate a system and method for conducting an auction over a global computer network, according to an embodiment of the present invention. The auction includes selective filtering and multi-round bidding, and is suitable for selecting lenders for placement on a school's preferred lender list, and for sales of education loan portfolios and forward purchase commitments.

As shown, FIG. 1 illustrates an auction system 100 that includes an offeror 102, a system administrator 104, and a plurality of bidders 108. Offeror 102 is in communication with system administrator 104 via a global computer network, and is the auction participant who either is requesting proposals or is offering an item for sale. For example, offeror 102 could be a school soliciting proposals for education loan programs, or a loan seller soliciting offers to buy existing or future loan volume.

System administrator 104 conducts the auction and mediates communications over the global computer network between offeror 102 and the plurality of bidders 108. This mediation involves, for example, maintaining a web site on the Internet that is accessible to offeror 102 and the plurality of bidders 108. Offeror 102 and the plurality of bidders 108 interact through this web site by, for example, posting RFPs, submitting proposals in response to RFPs, and selecting winning proposals. System administrator 104 can also mediate communications between offeror 102 and the plurality of bidders 108 using electronic mail (e-mail). For example, system administrator 104 can forward e-mail notifications advising auction participants of deadlines, stages, and results associated with auctions.

The plurality of bidders 108 is in communication with system administrator 104. Although, for illustration purposes, FIG. 1 shows only five bidders, the plurality of bidders 108 could include any number of bidders. Indeed, a significant benefit of the present invention is the large pool of bidders that offeror 102 is able to reach, to increase offeror 102's chances of receiving desirable bid proposals.

With reference to the system of FIG. 1, the flowchart of FIG. 2 outlines a method for conducting an auction, according to an embodiment of the present invention. As exemplified by CUE and PACE, the system and method provide an innovative auction that is implemented over a global computer network (e.g., the Internet) and that incorporates a unique multi-round format.

As shown in FIG. 2, in step 200, the auction begins with offeror 102 posting an RFP on the web site of system administrator 104. This RFP provides the data that a bidder needs to make a proposal. In other words, the RFP describes what offeror 102 is auctioning (e.g., the privilege of being listed on a preferred lender list) and the minimum requirements that responding bid proposals should meet. For example, an RFP offering slots on a preferred lender list might describe the school type, the servicer, the guarantor, and the minimum borrower benefits. For an RFP putting existing or future loan volume up for auction, an RFP might describe the loan types and options for portfolio disaggregation.

In step 202, bidders 108 review the RFP on the system administrator web site 104. Bidders 108 include the universe of bidders having access to the system administrator web site 104, which in practice would include more than the five representative bidders shown in FIG. 1. Each of bidders 108 reviews the RFP and decides whether to submit a proposal. In this example, five bidders 108 submit a proposal to web site 104 in response to the posted RFP.

In reviewing the RFP, bidders 108 review requirements and information about the offering institution. Bidders 108 also preferably have the ability to download the RFP to perform electronic pricing and to prepare a proposal. In an embodiment of the present invention, after reviewing the information, each of bidders 108 completes an online form on web site 104, which becomes a proposal to offeror 102.

After web site 104 receives the proposals, in step 204, web site 104 provides offeror 102 with access to the submitted proposals and enables offeror 102 to evaluate the proposals. Offeror 102 can provide access to each proposal immediately after the proposal is submitted, or can wait until after the deadline for submitting proposals has passed and provide access to all of the submitted proposals at once. Evaluation of the proposals can include, for example, filtering the proposals, exporting the proposals for further analysis, and evaluating the profiles of the entities that furnished the proposals. Filtering the proposals can include, for example, conducting searches based on certain characteristics, such as the name of a specific guarantor or servicer. In an embodiment of the present invention, only offeror 102 has access to review the proposals (e.g., in sealed bidding), thereby guaranteeing bidders 108 confidentiality.

After reviewing the proposals, in step 206, offeror 102 chooses either to award winners or to select bidders that qualify for a second round of bidding. This decision would depend on factors such as the quality of the initially submitted proposals and whether offeror 102 needs more information to differentiate the proposals. In an embodiment of the present invention, web site 104 notifies bidders 108 of offeror 102's decision via e-mail messages to each bidder, or alternatively, posts the results to a secured portion of web site 104. In any case, each bidder 108 preferably only learns of its bid result, and not the bid results of other bidders.

If offeror 102 is satisfied with at least one proposal and decides to award winner(s), then web site 104 notifies the winning bidder(s) of the favorable result in step 208.

In some situations, however, offeror 102 will want to conduct another round of bidding to encourage more refined proposals and more granular comparisons. In this case, offeror 102 selects from among bidders 108 for another round of bidding. To conserve time and administrative resources, offeror 102 can select bidders whose proposals most closely match the needs of offeror 102, and can exclude those bidders whose proposals show little promise. In this example, offeror 102 chooses bidders 110 from among the original bidders 108. Bidders 110 proceed to the next round of bidding.

Optionally (as represented by the dotted lines in FIG. 2), after choosing bidders 110, in step 210, offeror 102 is given the opportunity to revise the RFP, if offeror 102 so desires. In some cases, offeror 102 would want to revise the RFP to give the second round bidders 110 an indication of the additional information offeror 102 needs to reach a decision. In other words, the revised RFP would elicit revised proposals that better differentiate the proposals and bidders 110. Also in step 210, after revising the RFP (if desired), web site 104 posts the RFP for secured viewing by bidders 110.

In step 212, the second round bidders 110 view the (revised) RFP and submit revised proposals in the same manner as described for step 202. Likewise, in step 214, offeror 102 evaluates the revised proposals in the same manner as described for step 204.

After reviewing the revised proposal, in step 216, offeror 102 awards winners. Alternatively, offeror 216 has the option of awarding winners or selecting bidders for another round of bidding. If offeror 102 is still not satisfied with the proposals and elects to continue with another round of bidding, then offeror 102 selects bidders, from among bidders 110, that will go to the next round. The process then continues by returning to step 210 and looping between steps 210, 212, 214, and 216 until offeror 102 elects to award winners.

If, in step 216, offeror 102 chooses to award winners, then, in step 208, the auction ends and web site 104 notifies the winning bidders. In the example of FIG. 1, offeror 102 awards winners 112 from among the second round bidders 110. In an embodiment of the present invention, web site 104 notifies all bidders, whether winners or not, of the results of the auction. This notification can be an e-mail message, for example.

In an alternate embodiment of the present invention, system administrator 104 collects an escrow fee from bidders that submit proposals. System administrator 104 can collect this escrow fee upon submission of a first proposal (step 202), or can wait until a later round when the number of bidders is reduced and there is an increased likelihood that a bidder will win (e.g., step 210). If a bidder is subsequently chosen to be a winner, then system administrator 104 retains the escrow fee (e.g., steps 206 or 216). If a bidder is unsuccessful, then system administrator 104 returns the escrow fee to the bidder (e.g., steps 206 or 216).

### II. College and University Exchange (CUE)

CUE provides an e-commerce platform for the selection of lenders for placement on a school's preferred lender list. Specifically, CUE enables a school to efficiently solicit competitive bids from lenders based on the customized loan program features and services that the school needs. CUE's users include schools, whose students and parents require loan funding, and originating lenders, the providers of loan funding. With reference to FIG. 1, the schools correspond to offeror 102 and the lenders correspond to bidders 108. The operator of CUE is system administrator 104.

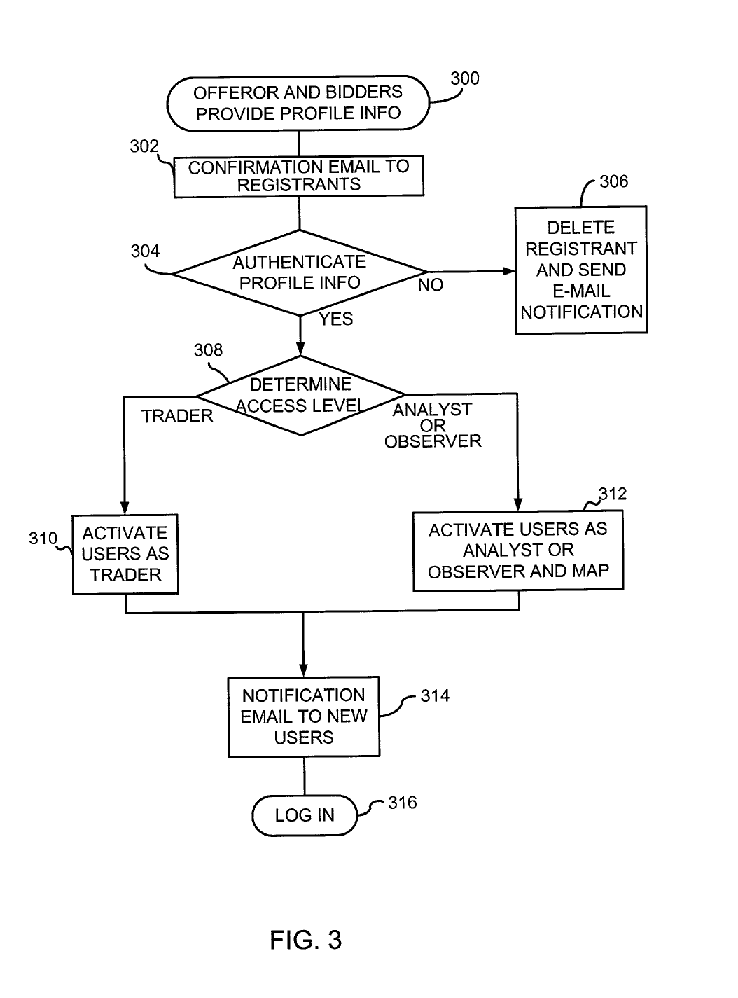

FIGS. 3-5 illustrate the system and method of CUE, according to an embodiment of the present invention. The flowcharts show the sequences of use cases, decision points in the workflow, and the locations at which the use cases are performed. (“Use cases” are collections of possible sequences of interactions between the system and external users, related to a particular goal.) As one of ordinary skill in the art would appreciate, not all use cases are represented in the flowcharts because many use cases are not involved in a sequence of activities.

FIG. 3 outlines the registration workflow for CUE users, including the processes of registering, authenticating, and logging on. As shown, schools and lenders register with system administrator 104 in the following manner. In step 300, the school (offeror 102) and the lenders (bidders 108) provide their own profile information and the profile information of their representative(s) that will be using CUE. The school and lenders designate one or more individuals to be their representatives, who are then able to access web site 104 using individually assigned identifications (IDs) and passwords. The school and lenders classify each of these representatives into one of three categories: trader, analyst, or observer.

The trader is a representative who has authority to submit content to web site 104 and has full access to all available functions of web site 104 (e.g., create, edit, and submit). For schools, the trader has authority to create, edit, and submit requests-for-proposals on behalf of the school. Typically, each registering school has one trader, although a school may have more than one trader if the school provides separate preferred lender lists for different divisions within the school (e.g., undergraduate division, medical school division, or law school division). For lenders, the trader has authority to create, edit, and submit proposals on behalf the lender that the trader represents.

An analyst has the authority to create content, such as RFPs or responses to RFPs, but does not have the authority to submit the content to web site 104. Thus, for schools, an analyst can write RFPs, but cannot formally submit the RFPs to the marketplace. Similarly, for lenders, an analyst can draft a response to an RFP but cannot submit it to web site 104 for posting.

Observers have the most limited authority. Specifically, observers have read-only access to content on web site 104. Thus, for schools, observers can only read RFPs, and cannot edit, draft, or submit the RFPs. Likewise, for lenders, observers can only read proposals, and cannot edit, draft, or submit the proposals.

After all of the profile information has been entered, in step 302, web site 104 sends an e-mail notification to the representatives to confirm that the profile information has been received. Web site 104 then turns to authenticating the profile information and establishing the access levels of the different representatives.

Thus, in step 304, web site 104 views the newly registered representatives and their profile information, and authenticates the profile information. Authentication can involve, for example, confirming the veracity of entered data against third party sources. If web site 104 cannot authenticate a registrant's profile information, then, in step 306, web site 104 deletes the registrant and sends an e-mail notification to the registrant reporting the failed authentication.

If, in step 304, the profile information is authenticated, then web site 104 determines to which access level the representative has been designated in step 308. If the representative is designated a trader, then, in step 310, web site 104 activates the representative as a user with the corresponding trader access privileges.

If the representative is an analyst or an observer, then, in step 312, web site 104 maps the representative to a corresponding trader and school or lender, and activates the representative as a user with access privileges corresponding to an analyst or an observer. In an embodiment of the present invention, each school or lender has at least one trader, and if additional representatives register, each is associated with, or mapped to, the trader and the school or lender.

After the representatives have been activated with appropriate access levels, in step 314 web site 104 sends e-mail notifications to the representatives confirming their ability to access web site 314. Thus, in step 316, the representatives can log in to web site 104.

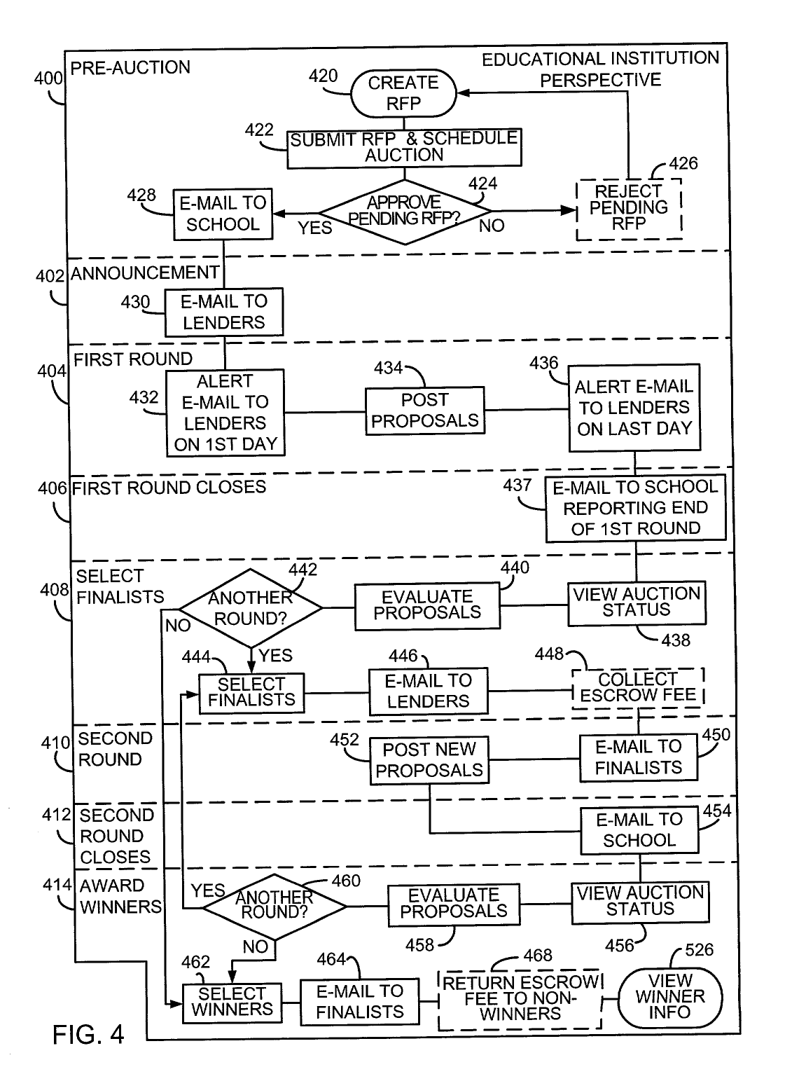

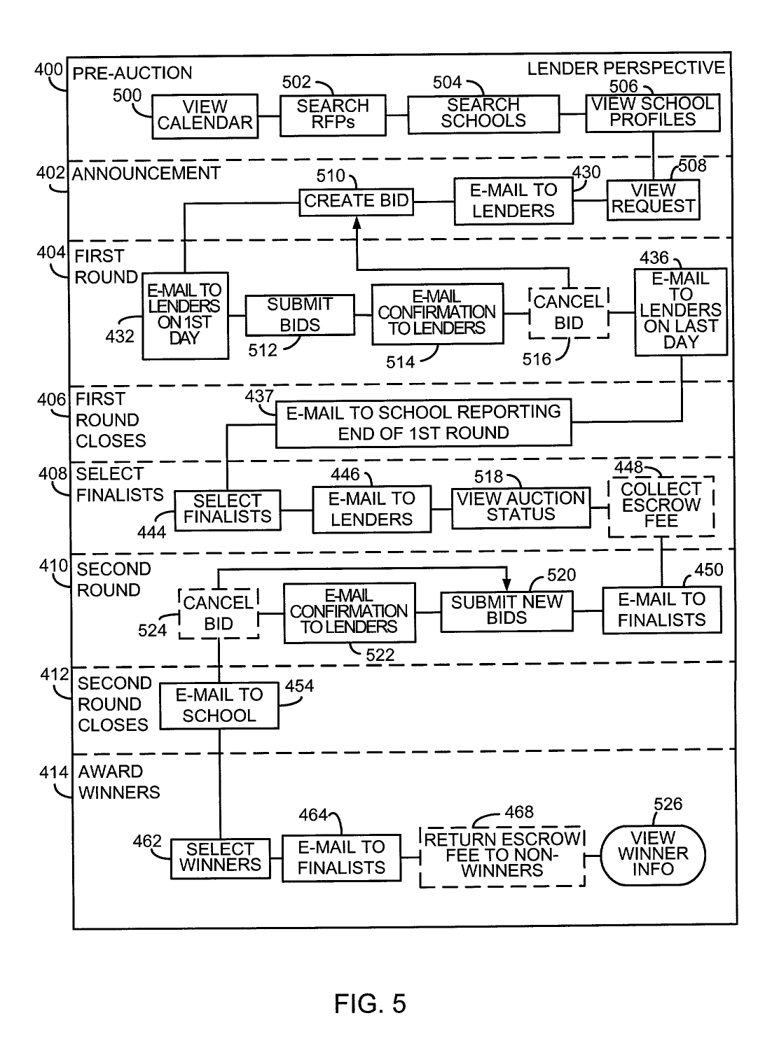

FIGS. 4 and 5 illustrate a method for conducting an auction, according to the CUE embodiment. FIG. 4 outlines the method from the perspective of an educational institution user of CUE. This perspective encompasses the processes of creating an RFP as a part of pre-auction set-up, announcing an auction, conducting the auction, and selecting winners. FIG. 5 outlines the method from the perspective of originating lender users of CUE. This perspective encompasses the processes of reviewing RFPs as a part of the pre-bidding set-up, preparing a bid, submitting a bid, and obtaining information about the results of the auction.

Both FIGS. 4 and 5 indicate the stages of the CUE auction process: pre-auction 400, announcement 402, first round 404, first round closes 406, select finalists 408, second round 410, second round closes 412, and award winners 414. Between FIGS. 4 and 5, steps shown within the same stage relate to each other.

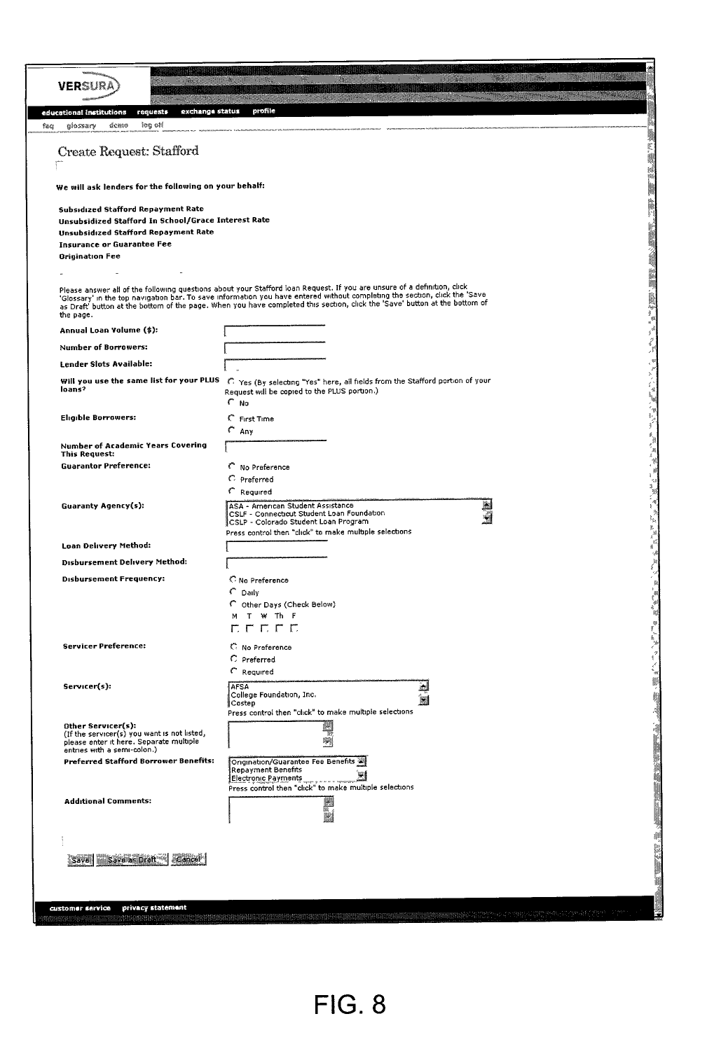

Referring now to both FIGS. 4 and 5, in step 420 of the pre-auction stage 400, traders and analysts of the school prepare and edit an RFP. Preferably, the traders and analysts prepare RFPs using standard templates displayed on web site 104, which have data fields corresponding to criteria typically included in an RFP. In addition, if necessary, the traders and analysts can duplicate RFPs to, for example, prepare many similar RFPs (e.g., if a school offers different loan programs to different school divisions) or to use a past RFP as a basis for creating a new RFP. The RFPs solicit, from prospective lenders, proposals to furnish education loans to the students of the school. As an example, the RFP can set parameters for the school's loan program by describing the loan program characteristics and services—including items like loan delivery methods and guarantor—that are important to the school. As an example, FIG. 8 illustrates a graphical user interface of a template for creating an RFP for a Stafford loan program.

After the traders and analysts finalize the details of the RFP that they wish to submit, in step 422, the trader formally submits it and schedules the transaction on CUE (e.g., noting an auction's start and end dates). Preferably, after the trader formally submits and schedules the RFP, the school cannot modify the RFP without action by the system administrator.

In step 424, the system administrator web site 104 examines the submitted RFP for errors and completeness and, if necessary, in step 426, returns the RFP to the trader in draft mode for correction and resubmission. After an RFP is approved and formally scheduled, in step 428, web site 104 generates an e-mail message to the school confirming the schedule.

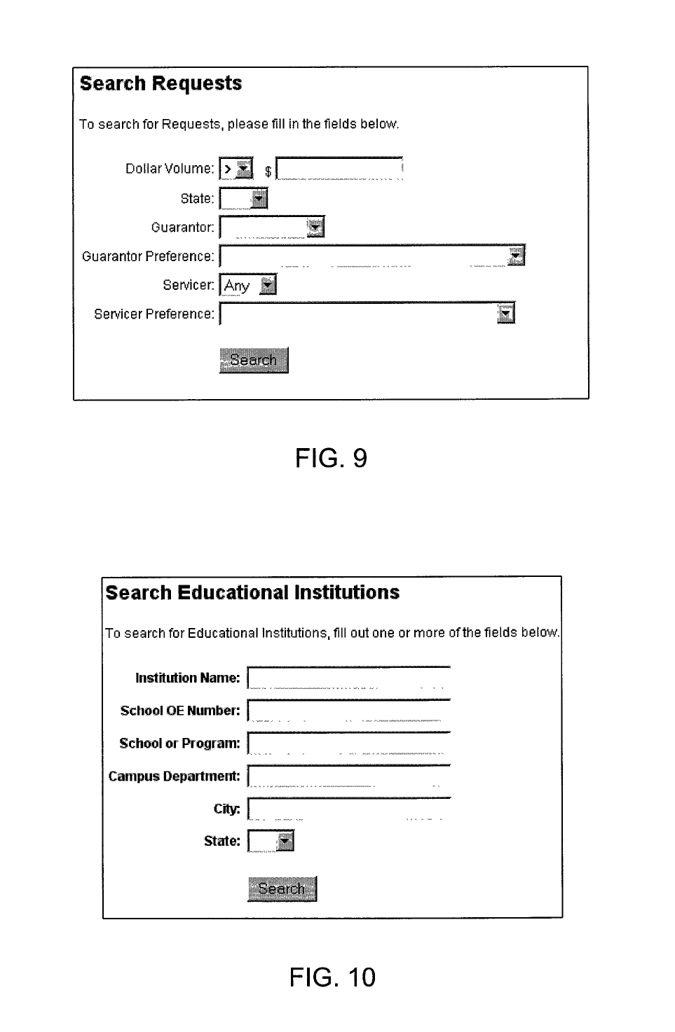

During the pre-auction stage 400, as shown in FIG. 5, lenders can view the auction calendar (step 500), search already-posted RFPs (step 502), search schools (step 504), and view school profile information (step 506). Lender representatives are able to view the details of all scheduled, open RFPs. The lender representatives can also search the RFPs online to identify RFPs that include specific features in which the lender is interested. FIG. 9 illustrates an exemplary graphical user interface through which a lender can search already-posted RFPs. FIG. 10 shows an exemplary graphical user interface through which a lender can search schools.

In the announcement stage 402, web site 104 forwards to the registered lenders e-mail announcements of the approved RFP and its schedule (e.g., start and end dates for submitting proposals), in step 430. Preferably, the system administrator web site 104 also periodically forwards alert e-mails to the lenders to keep them apprised of the status of the transaction.

In step 508 of announcement stage 402, after receiving the e-mail notification of the newly posted RFP, lenders view the RFP and its schedule to decide if they will respond with a proposal. In making this decision, the lenders can perform all of the functions of the pre-auction stage 400, such as viewing the calendar (step 500), searching other RFPs (step 502), searching schools (step 504), and viewing school profiles (step 506).

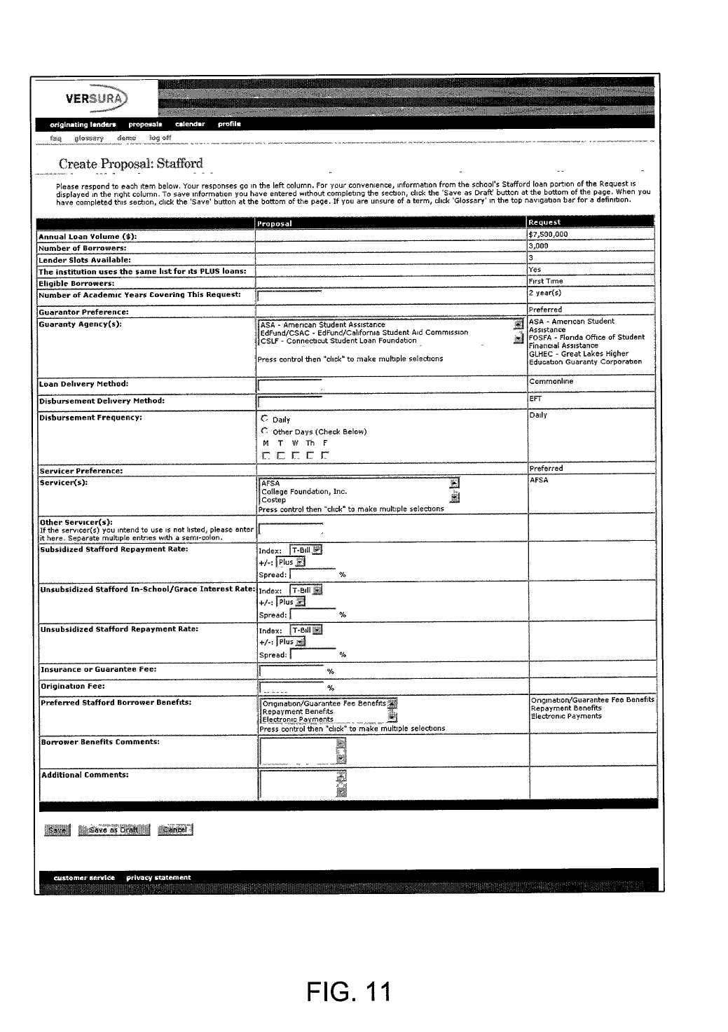

After identifying an RFP of interest, in step 510, the trader and analyst of a lender compose and edit a bid proposal. Preferably, they use standard data templates that correspond with the features detailed by the school in the RFP. As an example, FIG. 11 shows a graphical user interface through which a lender creates a proposal for a Stafford loan program corresponding to the RFP specifications entered by the school in FIG. 8.

According to an embodiment of the present invention, lenders can duplicate proposals, enabling the lenders to easily submit multiple proposals to a single request (varying in particular details) and to submit similar proposals to different schools or to different requests by the same school. For example, a lender can copy a previously saved proposal into a new proposal with a new name, can edit the information in the new proposal, and can submit the new proposal for a new RFP. This duplication feature streamlines data entry.

When the day of the start date of the auction arrives, the auction enters the first round stage 404. At this point, in step 432, web site 104 sends an e-mail notification to registered lenders reminding them that the period in which to submit proposals has started.

In this first round stage 404, after the lenders finalize their proposals, the traders formally submit the proposals to web site 104 in step 512 (FIG. 5). In an embodiment of the present invention, following this formal submission, a lender cannot change a proposal without the assistance of the system administrator. After receiving the submitted proposal, in step 514, web site 104 sends an e-mail notification to the lender confirming receipt. Web site 104 also posts the submitted proposals in step 434 (FIG. 4), for access by the school. Preferably, the school has secured access to the posted proposals such that no other school or lender can view the posted proposals (except, of course, lenders viewing their own proposals).

During the first round stage 404, lenders continue to submit proposals to web site 104, which web site 104 posts for review by the school. In an embodiment of the present invention, if a lender wants to retract a bid, then, in step 516, the lender cancels the bid proposal and returns to step 510, if desired, to create a new bid proposal. On the last day of the bid period set by the school, in step 436, web site 104 sends an e-mail notification to the lenders reporting that all proposals must be submitted by the deadline.

After the deadline passes, in step 437 of the close of the first round 406, web site 104 sends an e-mail notification to the school reporting that the first round has ended. The notification can also include details of the first round, such as the number of proposals received and the names of the bidders.

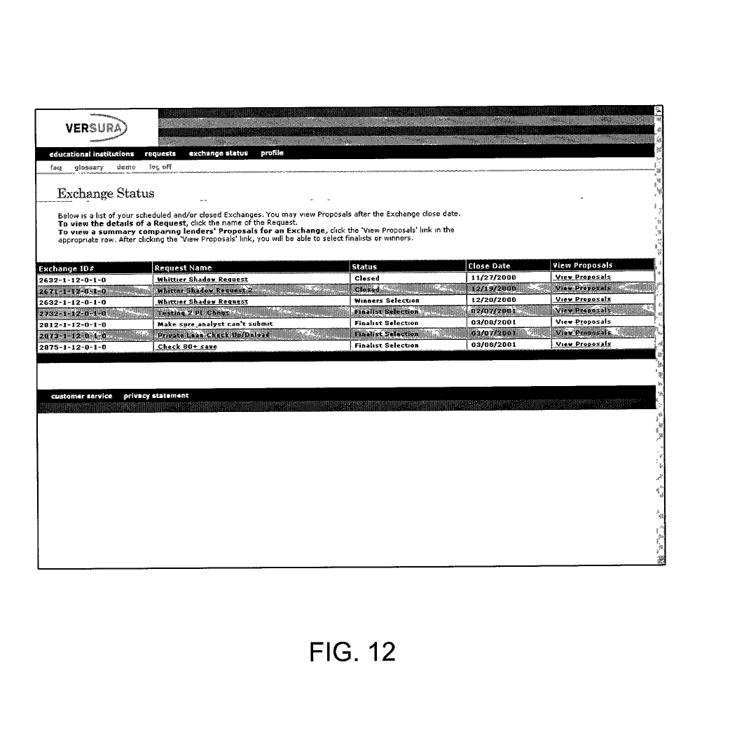

After the first round closes, in step 438 of the select finalists stage 408, the school views the status of the auction on web site 104. As an example, FIG. 12 illustrates a graphical user interface that shows the status of a school's current auctions.

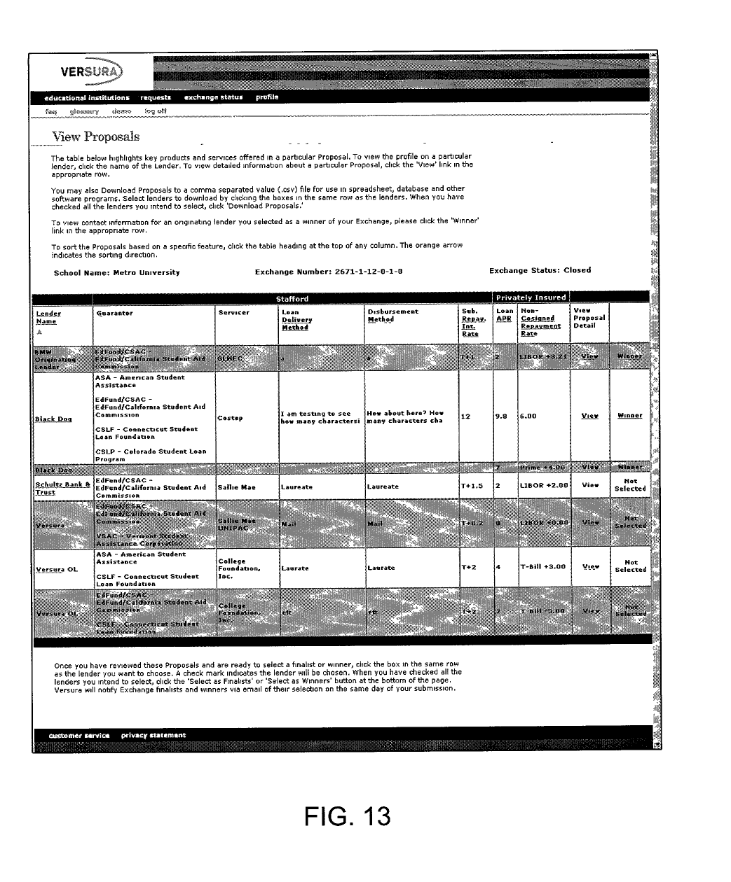

In step 440, the school evaluates the proposals. This evaluation includes, for example, viewing the profiles of lenders that have submitted proposals, viewing the details of bid proposals, filtering bid proposals, and exporting proposals for further analysis (e.g., by downloading the proposals into MICROSOFT EXCEL™ spreadsheet). To facilitate the school's evaluation, web site 104 displays the RFP requirements simultaneously with corresponding proposal elements to enable convenient comparisons. FIG. 13 illustrates an exemplary graphical user interface through which the school can evaluate proposals. Web site 104 can also simultaneously display the proposal elements of multiple lenders to enable convenient comparison. In filtering bid proposals, the school can isolate elements of the lender programs for direct comparison to the school's RFP criteria.

After reviewing the proposals, the school may take one of two tracks, as represented in step 442. That is, the school may select finalists to enter another round of bidding, or may award winners and conclude the auction. FIG. 13 illustrates an exemplary graphical user interface through which the school can select finalists or award winners. If the school elects to award one or more winners (most schools list more than one lender on their preferred lender list), then the process proceeds to step 462 (as described below) without entering another round of bidding.

If, in step 442, the school chooses to select finalists, then in step 444 the school identifies certain bidders as finalists. Optionally, at the same time, the school can revise the RFP if necessary. Then, in step 446, web site 104 sends e-mail notifications to each lender that submitted a proposal, advising the lender if it was selected as a finalist, or, optionally, asking the lender to visit web site 104 to see if was selected as a finalist. For those lenders that were selected, the e-mail notification or web site posting also asks the lender to review the revised RFP (if applicable), and to submit a revised proposal for a second round of bidding.

After notifying the lenders that the school has chosen finalists, in step 518 (FIG. 5) of the selecting finalists stage 408, the lenders can view the status of the auction on web site 104. The lenders that have been chosen as finalists can also view the revised RFP, if applicable. In an alternate embodiment of the present invention, after the finalists are chosen, in step 448, web site 104 collects an escrow fee from the finalists. This escrow fee ensures that the finalists are committed to participating in the remainder of the auction and, ultimately, to completing a transaction with the school.

The second round 410 of the auction begins in step 450 with web site 104 sending e-mail messages to the finalists, notifying them that the period in which to submit revised proposals has begun. In response, in step 520, the finalists (traders and analysts) create and submit new proposals to web site 104. As with step 510 above, for step 520, the finalists can duplicate and edit the proposals as needed.

In an embodiment of the present invention, after a finalist lender formally submits the revised proposal, the lender cannot change the proposal without the assistance of the system administrator. After receiving the submitted proposal, in step 522, web site 104 sends an e-mail notification to the lender confirming receipt. Web site 104 also posts the revised proposals in step 452 (FIG. 4), for access by the school.

In an embodiment of the present invention, if a finalist lender wants to retract a bid, then, in step 524, the lender cancels the bid proposal and returns to step 520, if desired, to create a new bid proposal.

After the second round bid period expires, in step 454 of the close of the second round 410, web site 104 sends an e-mail notification to the school reporting that the second round has ended. Then, in step 456 (FIG. 4) of the award winners stage 414, the school views the status of the auction on web site 104. In step 458, the school evaluates the revised proposals as it did above in step 440 of the select finalists stage 408.

After reviewing the revised proposals, the school may take one of two tracks, as represented in step 460. That is, the school may select bidders to enter another round of bidding, or may award winners and conclude the auction. If, in step 460, the school opts for another round of bidding, the process loops between step 444 and 460 until the school awards winners.

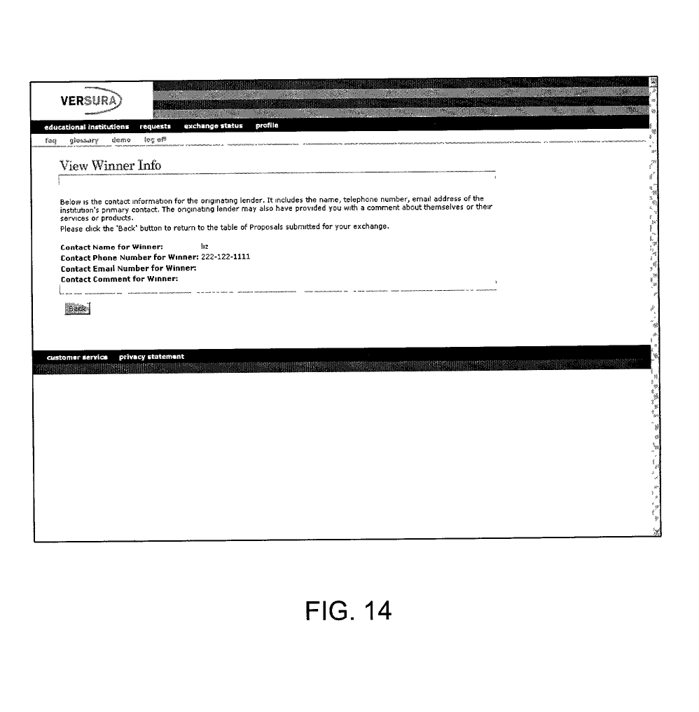

If, in step 460, the school elects to award one or more winners, then the school identifies the winners in step 462 (FIGS. 4 and 5). Then, in step 464, web site 104 sends e-mail notifications to each finalist lender, advising the lender if it is a winner. In step 526 (FIG. 5), the school and the lenders can view the winner information associated with the auction on web site 104. Preferably, at the conclusion of the auction, lenders are only able to view their own status (i.e., winner or loser) with respect to that auction, and do not have access to the names of (other) winners, nor any details of accepted proposals. FIG. 14 illustrates an exemplary graphical user interface that reports to a lender whether the lender has won the auction, for viewing only by that lender.

In an alternate embodiment of the present invention, after the winners are chosen, in step 468, web site 104 returns the escrow fee of any finalist that was not a winner. Web site 104 retains the escrow fees of the winners to pay at least a portion of the fee for placing the winning lenders on a preferred lender list.

By establishing an open marketplace, CUE provides one or more of the following benefits: 1) streamlines the development of preferred lender lists by schools; 2) maximizes value for borrowers and schools; 3) enables lending organizations to expand their reach to schools both within and outside of their current territory; and 4) enables lending institutions to reduce acquisition costs. The italicized subheadings below describe these benefits in more detail.

1) Streamline Preferred Lender List Creation—CUE saves schools time and energy when developing their preferred lenders lists. Rather than time-consuming meetings and negotiations with lenders, schools can devote more time to assisting students. CUE allows schools to quickly and efficiently state their and their students' educational loan needs, and deal with only those lenders willing to provide loan programs and services that have cleared the school's specially designed requirements.

RFPs for loan programs are generally regarded to be the best means for extracting value for loan programs. However, their use is limited by their cumbersome nature. CUE replaces the RFP process with an online form that allows schools to comprehensively address their loan program and services needs.

2) Maximize Loan Program Value—By facilitating competitive bidding on customized loan program features, CUE enables schools to efficiently reach and interact with a large pool of potential lenders. This expanded access translates into more favorable loan programs for the school and its students. CUE also maximizes the capital available to meet the borrowing needs of students, while delivering to schools greater efficiency in determining their preferred lenders. By replacing the traditional lender selection process, which consisted of inefficient lender-initiated direct mail and call campaigns and many face-to-face meetings, CUE frees school Financial Aid Administrators (FAAs) to spend more time working with their students.

CUE establishes a market-based mechanism to drive the customization of loan programs and maximizing of benefits. Using CUE, schools can set priorities among their loan program needs (e.g., improved loan access, higher private loan approval rates, improved services, preferred interest rates and fees, or other borrower benefits) and can stimulate creative and responsive proposals from lenders.

3) Expanded Loan Origination Opportunities—Most of the major originating lenders are banks, many of which claim to be “national” lenders. In actuality, few have a significant sales staff presence beyond the area of their branch-banking network. CUE enables any eligible lender to bid on loan volume at any school in the nation without hiring additional sales staff.

4) Reduced acquisition costs—The nationwide reach provided by the present invention gives lenders greater access to schools and borrowers. This enhanced access saves significant marketing expenses by enabling lenders to bid on lending opportunities nationwide without incurring additional staffing or travel expenses. In addition, for new lenders, the expanded reach substantially reduces the barriers to entering the originations marketplace.

CUE replaces and simplifies the RFP and proposal process for the respondent as well as the school. In the prior art, lenders typically established task forces or committees to respond to RFPs from key schools, often preparing responses that exceed 100 pages. By having the school clearly and succinctly define what is important and by providing a template for the lender response, CUE greatly reduces the time and effort required for major lenders to respond to RFPs.

An example of the opportunity presented by CUE can be seen with state agencies functioning as education lenders, which are able to use tax-exempt funding to offer superior loan terms and conditions to state residents and to students attending schools in the state. Awareness of these offerings is often limited, however, because state agencies typically do not have the marketing budgets and brand names of major or even local banks. CUE offers these state agencies the ability to promote their loan offerings on a level playing field with other lenders, bringing their cost-of-funds savings to more schools and borrowers.

### III. Portfolio and Commitment Exchange (PACE)

PACE provides an e-commerce platform for the business-to-business marketing of education loan portfolios and forward purchase commitments. This platform increases profitability for both buyers and sellers of education loans by reducing the cost of doing business and by creating a more liquid, open, and efficient market with widely distributed pricing information.

FIGS. 3, 6, and 7 are flowcharts illustrating an embodiment of the method of PACE. The flowcharts show the sequences of use cases, decision points in the workflow, and the locations at which the use cases are performed. As one of ordinary skill in the art would appreciate, not all use cases are represented in the flowcharts because many use cases are not involved in a sequence of activities.

FIG. 3 outlines the registration workflow for PACE users, including the processes of registering, authenticating, and logging on. According to an embodiment of the present invention, the registration workflow is the same as the process described under CUE, except that, in PACE, a loan seller corresponds to offeror 102 and a plurality of loan buyers corresponds to bidders 108. The loan seller and loan buyers designate representatives using the same three categories as described under CUE: trader, analyst, and observer, with the same level of access and rights as in CUE. In addition, the process for creating requests for bids and making bids is also the same as in the embodiments of CUE.

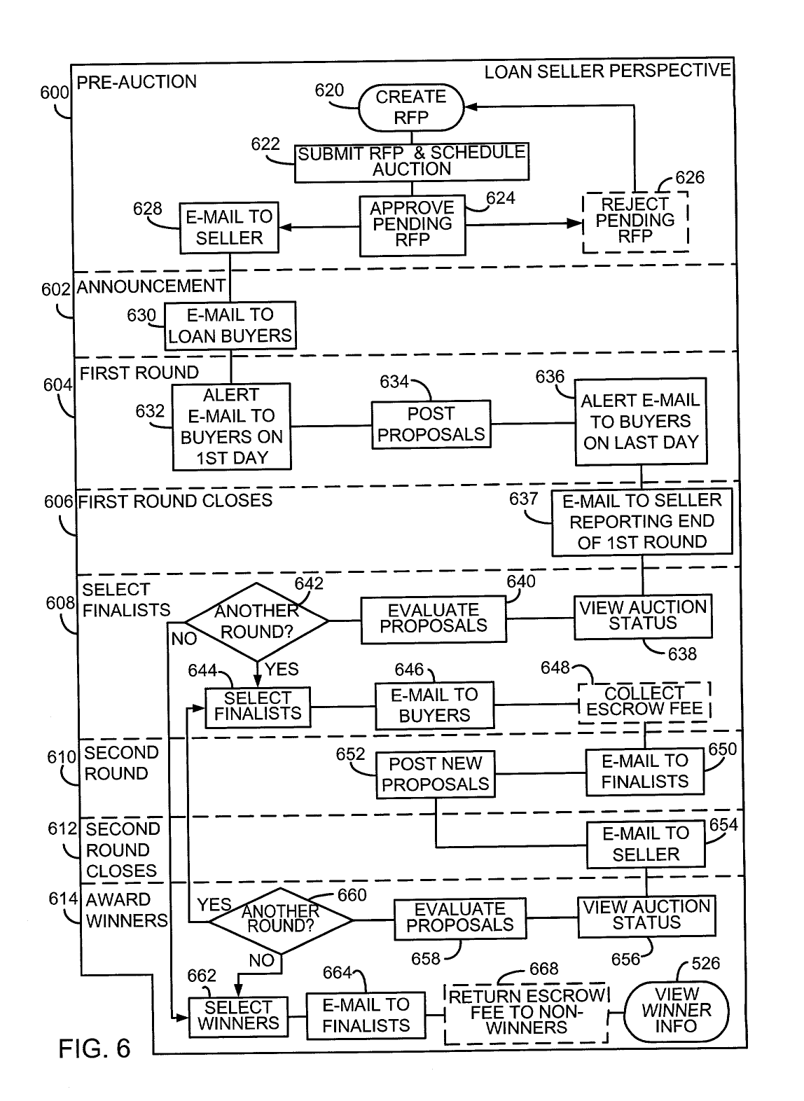

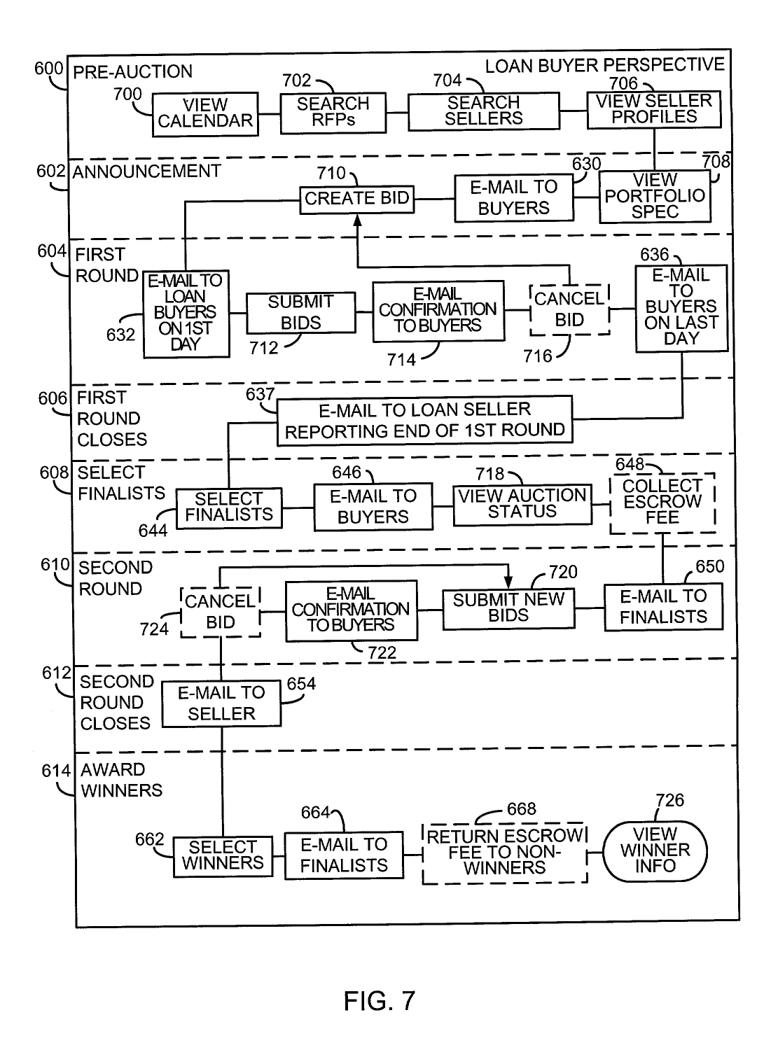

FIGS. 6 and 7 illustrate a method for conducting an auction, according to the PACE embodiment. FIG. 6 outlines the method from the perspective of a loan seller-user of PACE. This perspective encompasses the processes of creating a loan portfolio or forward purchase commitment specification (RFP) as a part of the pre-auction set-up, announcing the auction, conducting the auction, and selecting winners. FIG. 7 outlines the method from the perspective of loan buyer-users of PACE. This perspective encompasses the processes of reviewing RFPs as a part of the pre-auction set-up, announcing the auction, conducting the auction, and selecting winners.

As shown by the similarly numbered (i.e., same last two digits) steps between FIGS. 4 and 5 and FIGS. 6 and 7, the overall auction process of PACE operates in generally the same manner as described for CUE in reference to FIGS. 5 and 6. The few differences between CUE and PACE relate to the parties involved and the items being auctioned. For example, instead of the school and a plurality of lenders of CUE, PACE involves a loan seller and a plurality of loan buyers. As another example, instead of auctioning a slot on a preferred lender list as in CUE, PACE involves auctioning a loan portfolio or forward purchase commitment. Consequently, an RFP in PACE contains, for example, loan portfolio or forward purchase commitment specifications, rather than requirements of an education loan program. In most other respects, the auction processes of CUE and PACE are essentially the same.

As an example of the process shown in FIGS. 6 and 7, an RFP of a loan seller describes in detail the portfolios of the loan seller (step 620), addressing each loan type separately. The loan seller may place all or part of its loan portfolios in the spot market or may obtain forward purchase commitments. In a spot sale of Stafford loans, for example, the RFP may include data such as the average borrower indebtedness of a portfolio, the percentage of loans that are unsubsidized Stafford loans, and the current loan status (in-school, grace, and deferment) as a percentage of principal.

In response to the RFP, a loan buyer would prepare a proposal using a standard template that corresponds to the requirements of the RFP (step 710 of FIG. 7). For example, if a loan buyer wants to bid on a forward purchase commitment for Stafford loans, the template might ask the loan buyer to specify services that would be provided by the loan buyer, such as loan origination (in dollars per loan), in-school servicing (in dollars per month per program account), and grace loan servicing (in dollars per month per program account).

After the proposals are submitted (step 712 of FIG. 7), the loan seller can view the proposals online or download them for further analysis (step 640 of FIG. 6). As with the above-described CUE embodiment, the loan seller can display the proposals simultaneously for convenient comparisons. The process then continues through the stages (select finalists 608, second round 610, second round closes 612, and award winners 614) as described above for CUE.

According to an embodiment of PACE, a lender that owns or intends to originate education loans solicits bids online from prospective purchasers. The seller may offer either existing portfolio(s) of loans or the right to purchase loans to be made by that lender in the future (forward purchase commitment). The system permits sellers to solicit bids on different component parts of portfolios or commitment, since price may be maximized by sale of component parts of existing or future volume. Thus, a seller may solicit bids on the combined portfolio A+B+C, and individually on components A, B, and C. Likewise, a prospective purchaser may choose to submit bids on all or a portion of portfolios offered by sellers. The system also accommodates grid-based pricing in bids since, especially in forward purchase commitments, education loans are often sold at differential prices based on factors such as the average borrower indebtedness of the portfolio and the percentage of loans in the portfolio that are serial to prior loans to the same borrowers.

PACE benefits loan sellers by creating a deeper market, with fuller, more efficient pricing information. Traditional loan buyers gain by bidding on portfolios through the Internet, rather than through a lengthy series of meetings, trips, and negotiations. This streamlined process reduces marketing costs. In addition, PACE benefits new entrants by facilitating their understanding of and their access to a more efficient and national loan marketplace.

By establishing an open marketplace for education loan buyers and sellers, PACE provides the following benefits:

1) Extended Reach—PACE extends the reach of loan buyers and expands their bidding opportunities.

2) Structure Portfolios—PACE facilitates better structuring of portfolios for possible bidding and sale to multiple buyers.

3) Derivative Products—PACE improves the efficiency of the aggregation of education loan portfolios for securitization and for monetizing of derivative products, such as interest rate floors.

4) Lower Barriers to Entry—PACE attracts new entrants to the secondary market by providing an easy mechanism for the acquisition of education loans.

5) Efficient Portfolio Disaggregation Opportunities—Most of the major originating lenders are banks making loans in several states and then offering them for sale on a total portfolio basis. This bundling creates a situation in which various state or regional secondary markets may be well positioned to offer the best price for specific parts of the lender's portfolio. (Certain state-owned secondary markets are legally limited in the scope of loans they may legally acquire, such as only loans to residents of the state in question or for attendance at one of that state's colleges or universities.) However, there is no efficient way for the lender to structure separate portfolios properly, identify interested parties, and collect their bids. PACE enables selling lenders to structure their portfolios to obtain these potentially maximized returns, while also allowing any secondary market or other buyer to bid on loan sale volume from any lender in the nation without hiring additional sales staff.

6) Securitization Opportunities—Loan securitization became popular among some large education loan holders (particularly secondary markets) in the mid-1990s as an alternative means to finance loans and manage balance sheets, as well as a mechanism to generate fee income. Some institutions found that the effective cost of funds for a securitization was less than their institutional cost of funds. Other loan holders felt that the best use of their capital was to move the loans off balance sheet via a securitization. Finally, those institutions seeking to boost income in the current period found that gain-on-sale accounting enabled them to show higher profits through securitization than through an outright loan sale.

By rationalizing the secondary market for education loans and making it more efficient through faster and broader availability of pricing data and information about offered portfolios generally, PACE facilitates the process of accumulating education loan assets for securitization, opening the securitization door for many loan holders or new entrants who do not have the scale or knowledge to conduct education loan securitizations efficiently nor the relationships to access the market. PACE also enables traditional securitizers to accumulate education loans from large holders who do not wish to securitize.

In addition to offering an effective market mechanism for the FFELP and private education loans, PACE would, by establishing a continuous valuation process and an unbiased pricing mechanism, enable USDE to sell loans (or interests in loans) from the FDLP (currently about $60 billion of loans outstanding) in an open and fair market if the government should decide to do so. As noted above, 20 U.S.C. §1087i permits USDE to undertake these sales under certain circumstances. By using the auction process of the present invention, USDE could maximize the proceeds for taxpayers from sales of loan portfolios, shield itself from criticism relating to the selection of winning bids, and ensure a fair and unbiased methodology.

### IV. Revenue Mechanisms

According to an embodiment of the present invention, CUE earns revenues by collecting a scalable fee from each originating lender that wins placement on a preferred lender list. Unsuccessful lender-bidders preferably pay nothing. CUE may not charge a fee to schools posting requests-for-proposals. CUE may offer access to schools for these services at no charge because extensive use of CUE by schools will generate a larger lender customer base. If CUE is provided to a school at no cost, the school would preferably commit to select all the lenders for its preferred lender list from CUE's auction.

An example revenue model for CUE charges lenders a scalable fee roughly equal to ⅓ of the typical cost of developing and marketing loan programs (typically costing around 50 basis points or more annually). To encourage early participation by lenders, CUE may also offer charter fees that allow lenders to defer the payment timing on a portion of the fees. With the exemplary scalable fee, lenders therefore achieve significant cost savings by reducing marketing expenses and focusing on CUE as the mechanism to earn market share.

According to a representative embodiment of the present invention, PACE also earns revenues by charging sellers a scalable fee. PACE may offer services to buyers at no charge in order to achieve a strong market position.

As an example of a PACE revenue model, PACE charges sellers a scalable fee roughly equal to ⅓ of the typical cost of loan acquisitions. This scalable fee is minimal in comparison to the expected price improvement opportunity available to sellers through better, broader market information. In addition, this fee represents significant cost savings over the prior art.

According to this embodiment, PACE encourages selling lenders to select their buyers through the auction process. In turn, secondary markets participate in PACE in order to maintain or expand their share of the secondary market. Price transparency stimulates some traditional holders to sell, meaning a larger market for loan buyers. The reduced marketing costs and streamlined process appeals to secondary markets focusing on cost reduction opportunities.

### V. System Architecture

An embodiment of the present invention provides a secure web site through which qualified participants can offer and bid upon education loan opportunities. The web site is based on a standard 3-tiered architecture (e.g., a Sun Microsystems™ hardware platform with an Oracle™ database) with an auction engine modified to implement the processes described above (e.g., a heavily modified host auction application such as LiveExchange™ from Moai Technologies™). The web site includes one or more of the following functionalities:

a) Viewing of the product demo and partial content for site visitors (non-members);

b) Proprietary content for members;

c) Registration for the auction process;

d) Preparation, help, and frequently asked questions for the auction process;

e) Conducting the auction;

f) Monitoring the auction;

g) Exporting proposal data into CSV (Comma-Separated Values) files readable by most commercially-available spreadsheet and word processing software;

h) Selection of finalists and winners of the auction;

i) Evaluation and reporting of auction activity and results;

j) Personalization and customization of the auction history and tracking of content viewing; and

k) Provision of a cost calculator that offerors can use to analyze bidder proposals (e.g., to calculate the cost of a loan for a particular borrower over the life of the loan) and that offerors can provide to their customers for similar purposes.

In an embodiment of the present invention, CUE is scalable such that it can handle multiple auctions (e.g., 2,000 or more) at any one time, as each participating school is likely to have one or more auctions in any given year. Similarly, in this embodiment of the present invention, CUE is scalable to handle multiple lenders (e.g., 1,000 lenders) responding to the auctions. Many lenders will screen available bids to look for volume in their home regions. Some lenders may look at all volume opportunities nationwide.

In an embodiment of the present invention, PACE is scalable such that it can handle multiple simultaneous auctions (e.g., 1,000 or more) and multiple selling lender-users (e.g., approximately 1,000), many of whom will only conduct one auction per year on average. Similarly, in this embodiment of the present invention, PACE is scalable to handle multiple secondary market users. PACE enables secondary market users to look for volume only from their home regions, or to screen national portfolios looking for a portfolio segment from their regions on which to bid. PACE also enables secondary market users to looking at all volume opportunities nationwide.

### * * *

For illustration purposes, this specification has described embodiments of the present invention in the context of the education loan market. However, as one of ordinary skill in the art would appreciate, the present invention is useful for any number of transactions between offerors and bidders. For example, in addition to auctioning slots on preferred lender lists or auctioning loan portfolios or forward purchase commitments, the present invention could facilitate the bidding process used in the construction industry, in which owners post project RFPs and contractors submit corresponding bids to receive a construction contract. For this reason, and notwithstanding the particular benefits associated with using the present invention for the education loan market, the system and method described herein should be considered broadly useful for any transaction involving an offeror and a group of bidders.

In addition, in the specific context of the education loan market, the present invention is not limited to the examples described above (i.e., preferred lender lists and sales of loan portfolios or forward purchase commitments). Indeed, the present invention is useful for many other transactions relating to education loans. For example, the present invention can facilitate the auctioning of loan servicing rights, which would typically include all of the notification, billing, collection, and other due diligence activities that loan holders must perform in order to preserve the federal guarantee on the loans. Education loan holders, such as banks, secondary markets, and the federal government, could use the present invention to solicit proposals from third party providers of loan servicing.

As another example, the platform of the present invention could be used to auction guarantee rights. For instance, the federal government may seek third party guarantees on the government's own loan portfolio (equaling approximately $70 billion today). Guarantee agencies in the loan industry would, in this case, try to provide a low-cost or no-cost guarantee in order to have additional loan volume under their control for the purposes of default calculations.

Another example of an educational loan transaction supported by the present invention involves education loan derivatives. Specifically, because of the nature of the government's interest rate setting mechanism, loans may have rate floors that make them more or less valuable depending on the prevailing interest rate level. Financial instruments could be issued based on the value of the floors. The platform of the present invention could then facilitate the trading of these derivative instruments.

A final example relates to collection rights. In this case, a loan holder, after trying and failing to collect from defaulted borrowers, submits for and receives claim reimbursement from a guarantee agency and/or the federal government. In turn, to recoup costs, the guarantee agency and/or the federal government pay outside collection companies to pursue the defaulted borrowers. Using the platform of the present invention, the collection companies could bid for the right to handle the accounts of the defaulted borrowers.

In illustrating the present invention, this specification presents examples of business-to-business (“B2B”) transactions. One of ordinary skill in the art would appreciate, however, that the present invention is equally applicable to business-to-consumer (“B2C”) transactions. For example, consumers or groups of consumer could use the platform of the present invention to solicit loan offers from lenders. For instance, an aggregation of prospective borrowers (consumers) could specify loan requirements, could solicit proposals from lenders to meet those requirements, and could select one lender to serve the needs of all of the prospective borrowers. An aggregation of prospective borrowers could be, for example, all prospective borrowers from a particular state in the United States.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

What is claimed is:

1. A method for conducting an auction over a global computer network comprising the steps of:
posting a request-for-proposal from an offeror on a site of the global computer network;
receiving, at the site, proposals that respond to the request-for-proposal;
enabling the offeror to evaluate the proposals and to choose one of awarding winning bidders and selecting bidders that qualify for a second bidding round;
if the offeror chooses to select second round bidders,
receiving, at the site, new proposals from the second round bidders, and
enabling the offeror to evaluate the new proposals and award winning bidders; and
if the offeror chooses to award winning bidders, notifying the winning bidders and ending the auction.

2. The method of claim 1, wherein if the offeror chooses to select second round bidders, the method farther comprises the step of enabling the offeror to revise the request-for-proposal.

3. The method of claim 1, wherein the offeror is one of a school that is soliciting proposals for education loan programs and a loan seller that is soliciting offers to buy one of loans and forward purchase commitments.

4. The method of claim 1, wherein the auction is for one of loan servicing rights, loan guarantee rights, loan derivatives, loan collection rights, and a construction contract.

5. The method of claim 1, wherein the step of enabling the offeror to evaluate the proposals comprises allowing the offeror to filter the proposals, export the proposals, and review profiles of bidders that submitted the proposals.

6. The method of claim 1, wherein if the offeror selects bidders that qualify for a second bidding round, the method further comprises the step of enabling the offeror to select bidders that qualify for a third bidding round,
wherein if the offeror selects bidders that qualify for a third bidding round, the method further comprises repeating the following steps until the offeror chooses to award winning bidders:
receiving, at the site, revised proposals; and
enabling the offeror to evaluate the revised proposals and choose one of awarding winning bidders and selecting bidders that qualify for another bidding round.

7. The method of claim 1, wherein the offeror is a school and the bidders are lenders, and wherein the auction is for a slot on a preferred lender list of the school.

8. The method of claim 7, further comprising the step of collecting a fee from the winning bidders.

9. The method of claim 1, wherein the offeror is a loan seller and the bidders are loan buyers, and wherein the auction is for one of a loan portfolio and a forward purchase commitment.

10. The method of claim 9, further comprising the step of collecting a fee from the loan seller.

11. The method of claim 1, wherein the number of second round bidders is fewer than the number of proposals, and wherein the number of winning bidders is fewer than the number of second round bidders.

12. The method of claim 1, further comprising the steps of:
collecting an escrow fee from each of the second round bidders; and
returning the escrow fee to the second round bidders that are not chosen as winning bidders.

13. The method of claim 1, wherein the offeror is a plurality of prospective borrowers and the bidders are lenders, and the plurality of prospective borrowers is soliciting proposals from the lenders to provide loans to the plurality of prospective borrowers.

14. A system for conducting an auction comprising:
(a) an offeror that is offering an item, wherein the offeror generates a request-for-proposal;
(b) a system administrator site in communication with the offeror through a global computer network, wherein the system administrator site is adapted to post the request-for-proposal for accessing through the global computer network; and
(c) a plurality of bidders in communication with the system administrator through the global computer network, wherein the plurality of bidders view the request-for-proposal and submit proposals to the system administrator site,
wherein the system administrator site is adapted to
enable the offeror to view the proposals and to select finalist bidders from among the plurality of bidders,
accept revised proposals from the finalist bidders, and
enable the offeror to view the revised proposals and to award winning bidders from among the finalist bidders.

15. The system of claim 14, wherein the system administrator is further adapted to enable the offeror to revise the request-for-proposal after the offeror selects finalist bidders.

16. The system of claim 14, wherein the offeror is a school, the bidders are lenders, and the item is a slot on a preferred lender list of the school.

17. The system of claim 14, wherein the offeror is a loan seller, the bidders are loan buyers, and the item is a one of a loan portfolio and a forward purchase commitment.

18. The system of claim 14, wherein the offeror is a plurality of prospective borrowers, the bidders are lenders, and the item is the right to serve lending needs of the plurality of prospective borrowers.

19. The system of claim 14, wherein the system administrator site is a web site and the global computer network is the Internet.

20. The system of claim 14, wherein the item is one of a slot on a preferred lender list, a loan portfolio, a forward purchase commitment, loan servicing rights, loan guarantee rights, loan derivatives, loan collection rights, and a construction contract.

21. A method for conducting an auction comprising the steps of:
posting a request-for-proposal on a web site of a global computer network;
inputting into the web site proposals that respond to the request-for-proposal;
identifying finalist proposals from among the proposals, wherein the finalist proposals are associated with finalist bidders;
inputting into the web site revised proposals from the finalist bidders; and
identifying at least one winning proposal from among the revised proposals.

22. The method of claim 21, wherein, after the step of identifying finalist proposals, the method further comprises the step of posting a revised request-for-proposal on the web site for the finalist bidders to view.

23. The method of claim 21, wherein the request-for-proposal asks for proposals for one of providing an education loan program, purchasing a loan portfolio, purchasing a forward purchase commitment, providing loan servicing, providing loan guarantees, purchasing loan derivatives, and obtaining collection rights.

24. The method of claim 21, wherein the step of identifying finalist proposals comprises the steps of filtering the proposals, exporting the proposals, and reviewing profiles of bidders that submitted the proposals.

25. The method of claim 21, wherein the step of identifying at least one winning proposal comprises the steps of filtering the finalist proposals, exporting the finalist proposals, and reviewing profiles of bidders that submitted the finalist proposals.

26. The method of claim 21, further comprising the steps of:
collecting an escrow fee from each of the finalist bidders; and
returning the escrow fee to finalist bidders whose revised proposals are not chosen to be the at least one winning proposal.

27. The method of claim 21, further comprising the step of notifying, from among the finalist bidders, bidders who submitted the at least one winning proposal.

28. A method for selecting lenders for placement on a preferred lender list of a school comprising the steps of:
posting, on a web site, a request by the school, to lenders, asking the lenders for proposals to furnish a loan program to students of the school;
posting proposals from the lenders on the web site;
marking finalist lenders from among the lenders;
posting revised proposals from the finalist lenders on the web site; and
marking winning lenders from among the finalist lenders, wherein the winning lenders are to be placed on the preferred lender list.

29. The method of claim 28, wherein, after the step of marking finalist lenders, the method farther comprises the step of posting a revised version of the request on the web site.

30. The method of claim 28, wherein the step of posting proposals further comprises providing the school with secured access to the proposals.

31. The method of claim 28, wherein the step of marking finalist lenders further comprises the steps of:
enabling the school to filter and export the proposals; and
receiving an indication from the school of the finalist lenders, and
wherein the step of marking winning lenders further comprises the steps of:
enabling the school to filter and export the revised proposals; and
receiving an indication from the school of the winning lenders.

32. The method of claim 28, further comprising the steps of:
designating representatives of the school to be one of school traders, school analysts, and school observers;
enabling the school traders to create and edit the request, and to submit the request to the web site;
enabling the school analysts to create and edit the request, but not to submit the request;
enabling the school observers to view the request, but not to create, edit, or submit the request;
designating representatives of the lenders to be one of lender traders, lender analysts, and lender observers;
enabling the lender traders to create and edit the proposals and the revised proposals, and to submit the proposals and the revised proposals to the web site;
enabling the lender analysts to create and edit the proposals and the revised proposals, but not to submit the proposals and the revised proposals; and
enabling the lender observers to view the proposals and the revised proposals, but not to create, edit, or submit the proposals and the revised proposals.

33. The method of claim 28, further comprising the steps of:
collecting an escrow fee from each of the finalist lenders; and
returning the escrow fee to finalist lenders that are not marked as winning lenders.

34. The method of claim 28, further comprising the step of collecting a fee from each of the winning lenders.

35. A method for auctioning one of a loan portfolio and a forward purchase commitment of a loan seller comprising the steps of:
posting, on a web site, a request by the loan seller, to loan buyers, asking the loan buyers for proposals;
posting proposals from the loan sellers on the web site;
marking finalist loan buyers from among the loan buyers;
posting revised proposals from the finalist loan buyers on the web site; and
marking winning loan buyers from among the finalist loan buyers.

36. The method of claim 35, wherein, after the step of marking finalists, the method further comprises the step of posting a revised version of the request on the web site.

37. The method of claim 35, wherein the steps of posting proposals and posting revised proposals further comprise providing the loan seller with secured access to the proposals and the revised proposals.

38. The method of claim 35, wherein the step of marking finalist loan buyers further comprises the steps of:
enabling the loan seller to filter and export the proposals; and
receiving an indication from the loan seller of the finalist loan buyers, and
wherein the step of marking winning loan buyers further comprises the steps of:
enabling the loan seller to filter and export the revised proposals; and
receiving an indication from the loan seller of the winning loan buyers.

39. The method of claim 35, further comprising the steps of:
designating representatives of the loan seller to be one of loan seller traders, loan seller analysts, and loan seller observers;
enabling the loan seller traders to create and edit the request, and to submit the request to the web site;
enabling the loan seller analysts to create and edit the request, but not to submit the request;
enabling the loan seller observers to view the request, but not to create, edit, or submit the request;
designating representatives of the loan buyers to be one of loan buyer traders, loan buyer analysts, and loan buyer observers;
enabling the loan buyer traders to create and edit the proposals and the revised proposals, and to submit the proposals and the revised proposals to the web site;
enabling the loan buyer analysts to create and edit the proposals and the revised proposals, but not to submit the proposals and the revised proposals; and
enabling the loan buyer observers to view the proposals and the revised proposals, but not to create, edit, or submit the proposals and the revised proposals.

40. The method of claim 35, further comprising the steps of:
collecting an escrow fee from each of the finalist loan buyers; and
returning the escrow fee to finalist loan buyers that are not marked as winning loan buyers.

41. The method of claim 35, further comprising the step of collecting a fee from each of the winning loan buyers.
